(19) United States
(12) Patent Application Publication
(10) Pub. No.: US 2010/0227210 A1
(43) Pub. Date: Sep. 9, 2010

(54) NON-AQUEOUS ELECTROLYTE SECONDARY BATTERY AND METHOD FOR MANUFACTURING THE SAME

(76) Inventors: Masao Fukunaga, Osaka (JP); Hajime Nishino, Nara (JP)

Correspondence Address: MCDERMOTT WILL & EMERY LLP, 600 13TH STREET, NW, WASHINGTON, DC, 20005-3096, US

(21) Appl. No.: 12/682,154

(22) PCT Filed: Jun. 2, 2009
(86) PCT No.: PCT/JP2009/002459

§ 371 Date: Apr. 8, 2010

(30) Foreign Application Priority Data
Jun. 2, 2008 (JP) 2008-144573

(51) Int. Cl. H01M 2/18; H01M 2/02; H01M 10/04

(52) U.S. Cl. 429/129; 429/163; 29/623.5; 29/623.1

(57) ABSTRACT

The present invention relates to a non-aqueous electrolyte secondary battery and a manufacturing method thereof. An object of the present invention is to obtain a non-aqueous electrolyte secondary battery that has an improved non-aqueous electrolyte impregnation ability into a flat wound electrode group that includes a porous insulating layer that contains inorganic oxide particles and a binder, little deterioration of charge/discharge cycle characteristics, high voltage discharge ability and favorable productivity.

According to the present invention, in a non-aqueous electrolyte secondary battery 1 that includes a flat wound electrode group 2 and a battery case 9, the electrode group 2 including a positive electrode 5, a negative electrode 6, a separator 7 and a porous insulating layer 8, at least one crack is formed in the porous insulating layer 8 that lies at folded portions 2a of the electrode group 2.

### RELATED APPLICATIONS

This application is the U.S. National Phase under 35 U.S.C. §371 of International Application No. PCT/JP2009/002459, filed on Jun. 2, 2009, which in turn claims the benefit of Japanese Application No. 2008-144573, filed on Jun. 2, 2008, the disclosures of which Applications are incorporated by reference herein.

### TECHNICAL FIELD

The present invention relates to a non-aqueous electrolyte secondary battery and a method for manufacturing the same. More specifically, the present invention primarily relates to an improvement in the electrode group included in a non-aqueous electrolyte secondary battery.

### BACKGROUND ART

At an increasing rate, more and more electronic devices have become cordless and portable in recent years, and demand for small and lightweight yet high energy density secondary batteries is increasing as a power source for driving such electronic devices. In particular, the prevalence of cell phones is high throughout the world, and a variety of functions including a camera function, a one segment broadcast reception function and a music player function have been added to cell phones. Thus, it is imperative to use secondary batteries with an even higher capacity as a power source of cell phones. Currently, non-aqueous electrolyte secondary batteries are a mainstream secondary battery for electronic devices. Among them, lithium ion secondary batteries are attracting attention. Lithium ion secondary batteries have a high energy density and are capable of high voltage discharge.

A lithium ion secondary battery includes an electrode group that includes a positive electrode, a negative electrode and a separator, and a non-aqueous electrolyte. The separator has a function of electrically insulating the positive electrode and the negative electrode from each other and a function of retaining the non-aqueous electrolyte. As the separator, a porous resin film is primarily used. As a material thereof, polyolefins such as polyethylene and polypropylene are used. However, porous resin films tend to contract under high temperature conditions, so there still remains room for improvement in batteries that include a porous resin film in terms of safety.

Battery safety is evaluated by, for example, a nail penetration test. The nail penetration test is a method for evaluating battery safety by penetrating a battery with a nail from the battery surface to the electrode group within the battery so as to forcibly cause an internal short circuit, and checking the degree of heat generation. When a battery that includes a porous resin film is penetrated with a nail, the positive electrode and the negative electrode are electrically connected, and a short-circuit current flows between the current collectors via the nail, as a result of which Joule heat is generated. The Joule heat causes the porous resin film to contract, extending the short-circuited area. As a result, even more heat is generated, which may cause a phenomenon in which the battery temperature increases excessively. This phenomenon is called excessive heat generation.

A variety of proposals have been made to improve the safety of lithium ion secondary batteries that include a porous resin film. One proposal is to provide a porous insulating layer both between a positive electrode and a separator, and between a negative electrode and the separator, or either one of them (see, for example, Patent Document 1). Such a porous insulating layer contains, for example, an inorganic filler and a binder. As examples of the inorganic filler, inorganic oxides such as alumina, silica, magnesia, titania, zirconia are listed. As examples of the binder, polyvinylidene fluoride, polytetrafluoroethylene, polyacrylic acid-based rubber particles and so on are listed.

The technique of Patent Document 1 is very effective in improving the safety of a lithium ion secondary battery and can almost reliably prevent an internal short-circuit from extending. However, according to Patent Document 1, a flat electrode group that includes a positive electrode, a negative electrode, a separator and a porous insulating layer is produced. The flat electrode group is housed in a prismatic battery case together with a non-aqueous electrolyte so as to produce a prismatic battery, which is widely used as a power source for a portable electronic device or the like. In the flat electrode group, two end portions located in a direction perpendicular to the axis line (winding axis) of the flat electrode group are folded portions in which the electrode group is dense so the porosity is low. For this reason, the folded portion of the flat electrode group is not easily impregnated with a non-aqueous electrolyte compared to the flat portion of the flat electrode group, and the time required to impregnate it with a required amount of non-aqueous electrolyte increases, as a result of which battery productivity decreases. In addition, because the non-aqueous electrolyte impregnation is insufficient, it cannot be said that battery performance is not impaired.

Another proposal is that, when producing an electrode group by spirally winding a positive electrode and a negative electrode with a separator interposed therebetween, the positive electrode, the negative electrode and the separator are spirally wound while a tensile force is applied to one end of these elements, and a pressure is applied to the electrode group from outside with the use of a roll (see, for example, Patent Document 2). The battery of Patent Document 2 is a lithium ion secondary battery, but the battery does not include a porous insulating layer. The reason that a pressure is applied to the electrode group with a roller in Patent Document 2 is that it improves the contact between the positive and negative electrodes and the separator so as to improve battery output.

### PRIOR ART DOCUMENT

### Patent Document

Patent Document 1: Japanese Laid-Open Patent Publication No. 2006-318892

Patent Document 2: Japanese Laid-Open Patent Publication No. 2002-231316

### SUMMARY OF INVENTION

### Problem to be Solved by the Invention

It is an object of the present invention to provide a non-aqueous electrolyte secondary battery that includes a flat wound electrode group with a superior non-aqueous electrolyte impregnation ability at a folded portion and that has a high energy density, a high voltage discharge ability and favorable safety, and a method for manufacturing such a non-aqueous electrolyte secondary battery.

### Means for Solving the Problem

The present inventors conducted in-depth studies to solve the above problems. As a result, they found a configuration in which in a folded portion of a flat electrode group that includes a porous insulating layer, a crack is formed in at least the porous insulating layer. They also found that, with this configuration, the entire flat electrode group can be impregnated with a non-aqueous electrolyte approximately uniformly in a short time. They also found that battery safety is not impaired even when a crack is formed in the porous insulating layer at the folded portion. Based on these findings, the present inventors accomplished the present invention.

That is, the present invention relates to a non-aqueous electrolyte secondary battery including:

(a) a flat wound electrode group that includes a positive electrode, a negative electrode, a porous insulating layer that contains inorganic oxide particles and a binder, and a separator;

(b) a non-aqueous electrolyte; and

(c) a battery case,

wherein the flat wound electrode group has folded portions on both ends in a direction perpendicular to a thickness direction and an axis line, and

at least one crack is formed in the porous insulating layer where one or both of the folded portions is positioned.

It is preferable that the porous insulating layer has a thickness of 1 to 10 μm.

It is preferable that, in a cross section in a direction perpendicular to the axis line of the flat wound electrode group, the crack has a V shape, W-shape or U-shape.

It is preferable that the crack extends in a width direction of the porous insulating layer in a surface of the porous insulating layer.

It is preferable that the crack has a depth from the surface of the porous insulating layer of 80 to 100% of the thickness of the porous insulating layer.

According to a preferred embodiment of the present invention, a method for manufacturing such a non-aqueous electrolyte secondary battery includes an electrode group production step including:

(i) spirally winding a positive electrode and a negative electrode about a prescribed axis line with a separator and a porous insulating layer that contains inorganic oxide particles and a binder interposed therebetween so as to obtain a wound product, and

(ii) applying a pressure to the wound product so as to obtain a flat wound electrode group that has folded portions on both ends in a direction perpendicular to the axis line,

wherein the step (i) includes forming the porous insulating layer on a surface of either one or both of the positive electrode and the negative electrode and pressing a portion of the porous insulating layer where a folded portion is to be located so as to form a crack in the portion.

It is preferable that the portion of the porous insulating layer where a folded portion is to be located is pressed with a roll.

It is preferable that a compressive pressure applied to the portion of the porous insulating layer where a folded portion is to be located is 0.05 MPa to 2 MPa.

According to another preferred embodiment of the present invention, a method for manufacturing such a non-aqueous electrolyte secondary battery includes an electrode group production step including:

(i) spirally winding a positive electrode and a negative electrode about a prescribed axis line with a separator and a porous insulating layer that contains inorganic oxide particles and a binder interposed therebetween so as to obtain a wound product, and

(ii) applying a pressure to the wound product so as to obtain a flat wound electrode group that has folded portions on both ends in a direction perpendicular to the axis line,

wherein the step (i) includes forming the porous insulating layer that contains 2 to 5 wt % of the binder and a remaining amount of the inorganic oxide particles on a surface of either one or both of the positive electrode and the negative electrode.

According to still another preferred embodiment of the present invention, a method for manufacturing such a non-aqueous electrolyte secondary battery includes an electrode group production step including:

(i) spirally winding a positive electrode and a negative electrode about a prescribed axis line with a separator and a porous insulating layer that contains inorganic oxide particles and a binder interposed therebetween so as to obtain a wound product, and

(ii) applying a pressure to the wound product so as to obtain a flat wound electrode group that has folded portions on both ends in a direction perpendicular to the axis line,

wherein the step (ii) includes applying a pressure to the wound product in a temperature environment of 5° C. or less.

### Effect of the Invention

A non-aqueous electrolyte secondary battery according to the present invention includes a flat wound electrode group that has a favorable non-aqueous electrolyte impregnation ability, and has a high energy density, a high voltage discharge ability and superior safety. In addition, with the non-aqueous electrolyte secondary battery of the present invention, production costs are reduced.

According to a method for manufacturing a non-aqueous electrolyte secondary battery of the present invention, it is possible to selectively form a crack in a porous insulating layer at a folded portion of a flat wound electrode group, or the like. Even when a crack is formed, the performance of the electrode group shows little deterioration, so there is no problem with using the battery. By forming a crack, the non-aqueous electrolyte impregnation ability becomes approximately uniform throughout the electrode group, so the electrode group the entirety of which is approximately uniformly impregnated with a non-aqueous electrolyte can be obtained in a short time. That is, the time required to impregnate the electrode group with a non-aqueous electrolyte can be shortened. Accordingly, battery productivity can be improved significantly and battery production costs can be reduced.

### BRIEF DESCRIPTION OF THE DRAWINGS

FIG. 1 is a vertical cross-sectional view showing a simplified configuration of a main part of a non-aqueous electrolyte secondary battery according to an embodiment of the present invention.

FIG. 2 is a transverse cross-sectional view showing a simplified configuration of an electrode group included in the non-aqueous electrolyte secondary battery according to an embodiment of the present invention.

### MODE FOR CARRYING OUT THE INVENTION

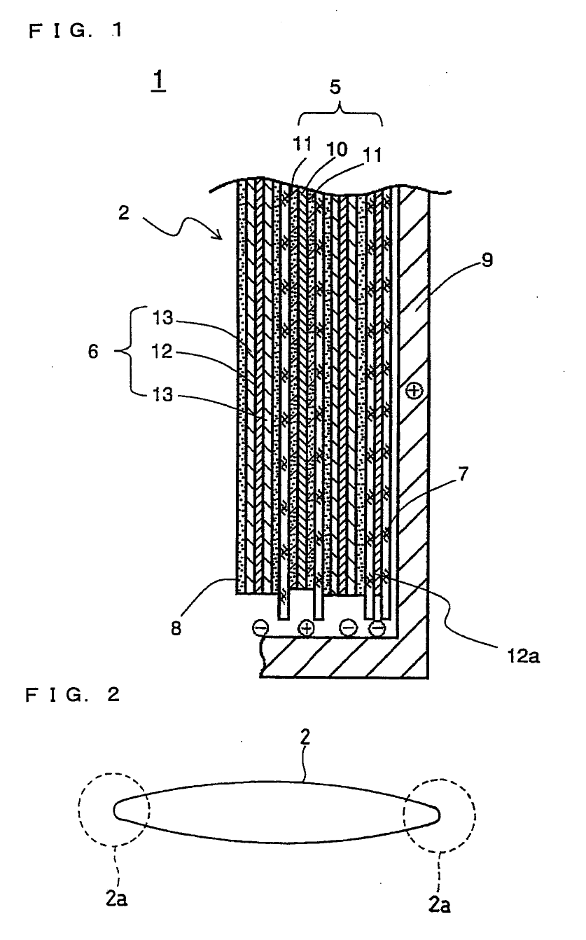

FIG. 1 is a vertical cross-sectional view showing a simplified configuration of a main part of a non-aqueous electrolyte secondary battery 1 according to an embodiment of the present invention. FIG. 2 is a transverse cross-sectional view showing a simplified configuration of an electrode group included in the non-aqueous electrolyte secondary battery 1 according to an embodiment of the present invention. In FIG. 2, only the shape of the outermost perimeter of the electrode group 2 is shown, and the inner part thereof is omitted.

The non-aqueous electrolyte secondary battery 1 is a prismatic lithium ion secondary battery that includes an electrode group 2, a battery case 9 and a non-aqueous electrolyte (not shown).

The electrode group 2 is a flat wound electrode group that includes a positive electrode 5, a negative electrode 6, a separator 7 and a porous insulating layer 8, and is housed inside the prismatic battery case 9.

Because the electrode group 2 is a flat wound electrode group, in two ends in a direction perpendicular to the thickness direction and the axis line (not shown), the positive electrode 5, the negative electrode 6, the separator 7 and the porous insulating layer 8 are folded in layers, forming folded portions 2a. The folded portions 2a are portions that have a low porosity because the positive electrode 5, the negative electrode 6, the separator 7 and the porous insulating layer 8 are folded and thus densely present.

According to the studies of the present inventors, it has been found that, at the folded portions 2a, by forming a crack (not shown) in at least the porous insulating layer 8, and preferably only in the porous insulating layer 8, the permeability of non-aqueous electrolyte into the electrode group 2 is improved while retaining the strength of the electrode group 2, and the safety, high energy density, and output characteristics of the battery 1, and the like. The crack and the method for forming a crack will be described in detail when describing the porous insulating layer 8 and a manufacturing method of the present invention, respectively. The direction perpendicular to the thickness direction refers to the same direction as the direction perpendicular to the axis line of the electrode group 2.

In this specification, the flat wound electrode group encompasses an electrode group obtained by spirally winding a positive electrode, a negative electrode and a separator interposed between the positive electrode and the negative electrode into a flat shape, and an electrode group obtained by spirally winding a positive electrode, a negative electrode and a separator interposed between the positive electrode and the negative electrode and, after that, shaping it into a flat shape. Such a flat wound electrode group has, in the center portion thereof, an axis line that is an imaginary line that extends in the longitudinal direction of the electrode group. The axis line is also called a winding axis. The flat wound electrode group has a flat shape in which a cross section in the direction perpendicular to the axis line has a long axis direction and a short axis direction. The flat wound electrode group is also called a flat plate-like wound electrode group.

As shown in FIG. 2, the folded portions 2a are located in the long axis direction of the cross section in the direction perpendicular to the axis line of the electrode group. As used herein, the thickness direction of the flat wound electrode group refers to a direction perpendicular to the long axis direction of the cross section in a direction perpendicular to the axis line of the electrode group.

The positive electrode 5 has a long shape, and includes a positive electrode current collector 10 and a positive electrode active material layer 11.

The positive electrode current collector 10 is a strip-shaped current collector that has a longitudinal direction and a width direction (transverse direction). As the strip-shaped current collector, for example, a metal foil made of stainless steel, aluminum, aluminum alloy, titanium or the like can be used. There is no particular limitation on the metal foil thickness, and it can be selected as appropriate according to various conditions, but the thickness is preferably 1 to 500 μm, and more preferably 5 to 20 μm.

The various conditions include, for example, the type of metal or alloy that constitutes the metal foil, the composition of the positive electrode active material layer 11, the configuration of the negative electrode 6, the composition of the non-aqueous electrolyte, the application of the battery 1, and so on. By selecting a metal foil thickness from the above range, a weight reduction in the battery 1 or the like can be achieved while retaining the rigidity of the positive electrode 5.

The positive electrode active material layer 11 is formed on one surface or both surfaces of the positive electrode current collector 10. In the present embodiment, positive electrode active material layers 11 are formed on both surfaces of the positive electrode current collector 10. The positive electrode active material layer 11 contains a positive electrode active material, and optionally a binder, a conductive material and the like.

As the positive electrode active material, any material that is usually used in the field of non-aqueous electrolyte secondary batteries can be used, but it is preferable to use a lithium-containing composite metal oxide, an olivine-type lithium salt or the like in consideration of capacity, safety and the like.

Examples of a lithium-containing composite metal oxide include LiₓCoO₂, LiₓNiO₂, LiₓMnO₂, LiₓCo_{y}Ni_{1-y}O₂, LiₓCo_{y}M₁₋_{y}O_{z}, LiₓNi_{1-y}M_{y}O_{z}, LiₓMn₂O₄, LiₓMn_{2-y}M_{y}O₄, Li₂MPO₄F (where M represents at least one element selected from the group consisting of Na, Mg, Sc, Y, Mn, Fe, Co, Ni, Cu, Zn, Al, Cr, Pb, Sb and B; x represents a molar ratio of lithium atoms and is 0 to 1.2; y represents a molar ratio of transition metal atoms or element M and is 0 to 0.9; z represents a molar ratio of oxygen atoms and is 2 to 2.3), and so on. The value of x representing a molar ratio of lithium atoms varies during charge and discharge, and is more preferably 0.8 to 1.5. The value of y is more preferably over 0, and 0.9 or less.

Examples of an olivine-type lithium salt include LiFePO₄ and so on. Such positive electrode active materials can be used alone or in a combination of two or more.

There is no particular limitation on the binder, and any material that is usually used in the field of non-aqueous electrolyte secondary batteries can be used. Examples include polyethylene, polypropylene, polyvinyl acetate, polymethyl methacrylate, nitrocellulose, fluorocarbon resin, rubber particles and so on. Examples of a fluorocarbon resin include polytetrafluoroethylene (PTFE), polyvinylidene fluoride (PVDF), tetrafluoroethylene-hexafluoropropylene copolymer (FEP), vinylidene fluoride-hexafluoropropylene copolymer, and so on. Examples of rubber particles include styrene-butadiene rubber particles, acrylonitrile rubber particles, and so on. Such binders can be used alone or in a combination of two or more as necessary.

As the conductive material, for example, carbon materials can be used, including graphites such as natural graphite and artificial graphite, and carbon blacks such as acetylene black, ketjen black, channel black, furnace black, lamp black and thermal black. Such conductive materials can be used alone or in a combination of two or more.

The positive electrode active material layer 11 can be formed by, for example, applying a positive electrode material mixture paste onto a positive electrode current collector surface, drying and optionally rolling it. The positive electrode material mixture paste can be prepared by, for example, adding a positive electrode active material to a dispersing medium optionally together with a binder, a conductive material and the like and mixing them. AS the dispersing medium, for example, N-methyl-2-pyrrolidone (NMP), tetrahydrofuran, dimethylformamide or the like can be used. The thickness of the formed positive electrode active material layer 11 is preferably, but not particularly limited to, 50 to 200 μm.

The negative electrode 6 has a long shape, and includes a negative electrode current collector 12 and a negative electrode active material layer 13. In the outermost perimeter of the electrode group 2, an exposed portion 12a of the negative electrode current collector 12 is disposed.

The negative electrode current collector 12 is a strip-shaped current collector that has a longitudinal direction and a width direction, as with the positive electrode current collector 10. As the strip-shaped current collector, for example, a metal foil made of stainless steel, nickel, copper, copper alloy or the like can be used. There is no particular limitation on the metal foil thickness, and it can be selected as appropriate according to various conditions, but the thickness is preferably 1 to 500 μm, and more preferably 5 to 20 μm. The various conditions include, for example, the type of metal or alloy that constitutes the metal foil, the composition of the negative electrode active material layer 13, the configuration of the positive electrode 5, the composition of the non-aqueous electrolyte, the application of the battery 1, and so on. By selecting a metal foil thickness from the above range, weight reduction of the battery 1 or the like can be achieved while retaining the rigidity of the negative electrode 6.

The negative electrode active material layer 13 is formed on one surface or both surfaces of the negative electrode current collector 12. In the present embodiment, the negative electrode active material layer 13 is formed on both surfaces of the negative electrode current collector 12. The negative electrode active material layer 13 contains a negative electrode active material, and optionally a binder, a conductive material, a thickener and the like.

Examples of a negative electrode active material include a carbon material, an alloy-based negative electrode active material, an alloy material, and so on. Examples of a carbon material include various types of natural graphite, coke, carbon undergoing graphitization, carbon fiber, spherical carbon, various types of artificial graphite, amorphous carbon, and so on. The alloy-based negative electrode active material is an active material capable of absorbing and desorbing lithium by being alloyed with lithium. Examples of an alloy-based negative electrode active material include a silicon-containing alloy-based negative electrode active material, a tin-containing alloy-based negative electrode active material, and so on.

Examples of a silicon-containing alloy-based negative electrode active material include silicon, a silicon oxide, a silicon nitride, a silicon-containing alloy, a silicon compound, and so on. The silicon oxide can be silicon oxide represented by a composition formula: SiOₐ (0.05<a<1.95). The silicon nitride can be a silicon nitride represented by a composition formula: SiN_{b} (0<b<4/3). The silicon-containing alloy can be an alloy that contains silicon and one or more elements selected from the group consisting of Fe, Co, Sb, Bi, Pb, Ni, Cu, Zn, Ge, In, Sn and Ti. The silicon compound can be any material other than silicon, a silicon oxide, a silicon nitride and a silicon-containing alloy, and examples include a compound in which part of the silicon included in silicon, a silicon oxide, a silicon nitride or a silicon-containing alloy is substituted by one or more elements selected from the group consisting of B, Mg, Ni, Ti, Mo, Co, Ca, Cr, Cu, Fe, Mn, Nb, Ta, V, W, Zn, C, N and Sn.

Examples of a tin-containing alloy-based negative electrode active material include tin, a tin oxide, a tin-containing alloy, a tin compound, and so on. The tin oxide can be, for example, SnO₂, a tin oxide represented by a composition formula: SnO_{d} (0<d<2), or the like. Examples of a tin-containing alloy include a Ni—Sn alloy, a Mg—Sn alloy, a Fe—Sn alloy, a Cu—Sn alloy, a Ti—Sn alloy, and so on. The tin compound can be any material other than tin, a tin oxide, and a tin-containing alloy, and examples include SnSiO₃, Ni₂Sn₄, Mg₂Sn, and so on.

Such negative electrode active materials can be used alone or in a combination of two or more.

As the binder and the conductive material that can be contained in the negative electrode active material layer 13, the same materials as those listed as the binder and the conductive material that can be contained in the positive electrode active material layer 11 can be used. Preferred binders include fluorocarbon resin, styrene butadiene rubber, and so on. The thickener can be, for example, carboxymethyl cellulose or the like.

The negative electrode active material layer 13 can be formed by, for example, applying a negative electrode material mixture paste onto the surface of the negative electrode current collector 12, drying and optionally rolling it. The negative electrode material mixture paste can be prepared by, for example, adding a negative electrode active material to a dispersing medium optionally together with a binder, a conductive material, a thickener and the like, and mixing them. As the dispersing medium, for example, N-methyl-2-pyrrolidone (NMP), tetrahydrofuran, dimethylformamide, water or the like can be used. The thickness of the formed negative electrode active material layer 13 is preferably, but not particularly limited to, 50 to 200 μm.

In the case of using an alloy-based negative electrode active material as the negative electrode active material, the negative electrode active material layer may be formed by a vapor deposition method, a sputtering method, a chemical vapor deposition or the like.

The separator 7 is disposed between the positive electrode 5 and the negative electrode 6, and insulates the positive electrode 5 and the negative electrode 6 from each other. The separator 7 can be, for example, a porous sheet made of a synthetic resin. Examples of the synthetic resin that constitutes the porous sheet include polyolefins such as polyethylene and polypropylene, polyamide, polyamideimide, and so on. The porous synthetic resin sheet also includes a non-woven fabric made of resin fiber, a woven fabric made of the same, and so on. Among them, a porous sheet that has pores formed inside thereof with a diameter of about 0.05 to 0.15 μm is preferable. Such a porous sheet has a high level of ion permeability, mechanical strength and insulation. The thickness of the porous sheet can be, for example, 5 to 20 μm.

The porous insulating layer 8 is disposed both between the positive electrode 5 and the separator 7, and between the negative electrode 6 and the separator 7, or either one of them. In the present embodiment, the porous insulating layer 8 is disposed between the negative electrode 6 and the separator 7 and, more specifically, the porous insulating layer 8 is carried on the surface of the negative electrode active material layer 13. It is preferable that the porous insulating layer 8 is carried on or attached to the surface of the positive electrode active material layer 11 or negative electrode active material layer 13, as just described above.

The porous insulating layer 8 can be, for example, an inorganic oxide particle film with high heat resistance. The inorganic oxide particle film has a function of preventing a short-circuited area from extending, for example, in the event of an internal short circuit, during a nail penetration test or the like. Accordingly, it is necessary to form the inorganic oxide particle film by using a material that does not contract by reaction heat.

The inorganic oxide particle film contains, for example, inorganic oxide particles and a binder.

By using inorganic oxide particles, it is possible to obtain an inorganic oxide particle film that has superior heat resistance and stability. As the inorganic oxide particles, for example, alumina, magnesia or the like is preferable in consideration of the electrochemical stability. The inorganic oxide particles preferably have a median diameter based on volume of, for example, 0.1 to 3 μm from the view point of obtaining an inorganic oxide particle film that has appropriate pores and an appropriate thickness. Such inorganic oxides can be used alone or in a combination of two or more.

It is preferable that the binder that can be contained in the inorganic oxide particle film has high heat resistance, and is amorphous. Upon occurrence of an internal short circuit, short-circuit reaction heat over several hundreds ° C. may be generated locally. If a crystalline binder with a low melting point or an amorphous binder with a low decomposition start temperature is used, deformation of the inorganic oxide particle film, separation of the inorganic oxide particle film from the positive electrode 5 or the negative electrode 6, or the like occurs, as a result of which the internal short circuit may further extend. It is preferable that the binder has heat resistance that does not cause softening, deformation, melting, decomposition or the like, for example, at a temperature of 250° C. or more. Examples of the binder include a rubbery polymer compound containing an acrylonitrile unit, and so on.

There is no particular limitation on the amounts of inorganic oxide particles and binder contained in the inorganic oxide particle film, but it is preferable that the amount of inorganic oxide particles is 92 to 99 wt % of the total amount of the inorganic oxide particle film, and the remaining amount is for binder.

The inorganic oxide particle film can be formed, for example, in the same manner as the positive electrode active material layer 11 and the negative electrode active material layer 13. Specifically, inorganic oxide particles and a binder are dispersed or dissolved in a dispersing medium to prepare a coating solution, and the coating solution is applied onto an active material layer surface and dried. In this manner, an inorganic oxide particle film can be formed. The thickness of the inorganic oxide particle film is preferably 1 to 10 μm.

In the present invention, at either one or both of two folded portions 2a of the electrode group 2, one or more cracks are formed in the porous insulating layer 8. By forming cracks, the permeability of non-aqueous electrolyte into the electrode group 2 can be improved, and the time required for impregnation of non-aqueous electrolyte during the production process of the battery 1 can be shortened, as a result of which the productivity of the battery 1 can be improved.

It is preferable that cracks are formed on the surface of the porous insulating layer 8. By doing so, not only the non-aqueous electrolyte impregnation ability is improved, but also the durability of the porous insulating layer 8 is maintained at approximately the same level as the porous insulating layer 8 at the no-crack portion. Consequently, the function of improving battery safety is exhibited sufficiently throughout the service life of the battery.

It is preferable that cracks have a V shape, a W shape or a U shape. By doing so, the non-aqueous electrolyte impregnation ability and the non-aqueous electrolyte retention ability of the electrode group 2 are improved. In addition, the strength of the porous insulating layer 8 can be maintained to the degree that does not cause any problem in practical use. As used herein, the shape of cracks is the shape of a cross section in a direction perpendicular to the axis line of the electrode group 2. Also, it is preferable that when the cross section is viewed from a positional relationship in which the outermost layer of the electrode group 2 is positioned vertically above and the axis line of the electrode group 2 is positioned vertically below, the shape of cracks is V-shaped, W-shaped or U-shaped.

It is preferable that cracks are formed in the surface of the porous insulating layer 8 such that the cracks extend in the width direction of the porous insulating layer 8. By doing so, the strength of the porous insulating layer 8 is maintained to a degree that does not cause any problem in practical use, and the safety of the battery 1 is maintained at approximately the same level as in initial use. It should be noted that the width direction of the porous insulating layer 8 is the same as the direction in which the axis line of the electrode group 2 extends.

It is preferable that the depth of the cracks from the surface of the porous insulating layer 8 is 50 to 100% of the thickness of the porous insulating layer 8, and more preferably 80 to 100%. When the crack depth is less than 80%, the non-aqueous electrolyte impregnation ability at the folded portion 2a of the electrode group 2 is reduced, as a result of which impregnation of non-aqueous electrolyte into the entire electrode group 2 may become non-uniform. In addition, the impregnation of non-aqueous electrolyte into the electrode group 2 may be reduced at the folded portion 2a.

Examples of a non-aqueous electrolyte include a liquid non-aqueous electrolyte, a gel non-aqueous electrolyte, a solid electrolyte (e.g., a polymer solid electrolyte), and so on.

A liquid non-aqueous electrolyte contains a solute (supporting salt) and a non-aqueous solvent, and optionally various additives. The solute usually dissolves in a non-aqueous solvent. A liquid non-aqueous electrolyte is impregnated into, for example, the separator 7 and the porous insulating layer 8.

As the solute, any material that is usually used in this field can be used, and examples include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lithium lower aliphatic carboxylate, LiCl, LiBr, LiI, chloroborane lithium, a borate, an imide, and so on.

Examples of a borate include lithium bis(1,2-benzenediolate(2-)-O,O′)borate, lithium bis(2,3-naphthalenediolate(2-)-O,O′)borate, lithium bis(2,2′-biphenyldiolate(2-)-O,O′)borate, lithium bis(5-fluoro-2-olate-1-benzene sulfonic acid-O,O′)borate, and so on.

Examples of an imide include lithium bis-trifluoromethanesulfonyl imide ((CF₃SO₂)₂NLi), lithium trifluoromethanesulfonyl nonafluorobutanesulfonyl imide ((CF₃SO₂) (C₄F₉SO₂)NLi), lithium bis-pentafluoroethane sulfonyl imide ((C₂F₅SO₂)₂NLi), and so on.

Such solutes may be used alone or in a combination of two or more as necessary. It is desirable that the amount of solute dissolved in a non-aqueous solvent is within a range of 0.5 to 2 mol/L.

As the non-aqueous solvent, any solvent that is usually used in this field can be used, and examples include a cyclic carbonic acid ester, a chain carbonic acid ester, a cyclic carboxylic acid ester, and so on. Examples of a cyclic carbonic acid ester include propylene carbonate (PC), ethylene carbonate (EC), and so on. Examples of a chain carbonic acid ester include diethyl carbonate (DEC), ethyl methyl carbonate (EMC), dimethyl carbonate (DMC), and so on. Examples of a cyclic carboxylic acid ester include γ-butyrolactone (GBL), γ-valerolactone (GVL), and so on. Such non-aqueous solvents may be used alone or in a combination of two or more as necessary.

As the additives, for example, a material that improves charge/discharge efficiency, a material that inactivates the battery, and so on can be used. The material that improves charge/discharge efficiency is, for example, decomposed in the negative electrode and forms a coating film that has a high lithium ion conductivity, thereby improving charge/discharge efficiency. Specific examples of such a material include vinylene carbonate(VC), 4-methylvinylene carbonate, 4,5-dimethylvinylene carbonate, 4-ethylvinylene carbonate, 4,5-diethylvinylene carbonate, 4-propylvinylene carbonate, 4,5-dipropylvinylene carbonate, 4-phenylvinylene carbonate, 4,5-diphenylvinylene carbonate, vinylethylene carbonate (VEC), divinylethylene carbonate, and so on. These may be used alone or in a combination of two or more. Among them, it is preferable to use at least one selected from vinylene carbonate, vinylethylene carbonate and divinylethylene carbonate. In the above compounds, some of the hydrogen atoms may be substituted by a fluorine atom.

The material that inactivates the battery is, for example, decomposed when the battery is overcharged and forms a coating film on the electrode surface, thereby inactivating the battery. Examples of such a material include a benzene derivative. Examples of a benzene derivative include a benzene compound that contains a phenyl group and a cyclic compound group that is adjacent to the phenyl group. Preferred examples of a cyclic compound group include a phenyl group, a cyclic ether group, a cyclic ester group, a cycloalkyl group, a phenoxy group, and so on. Specific examples of a benzene derivative include cyclohexylbenzene, biphenyl, diphenylether, and so on. Such benzene derivatives may be used alone or in a combination of two or more. However, it is preferable that the amount of benzene derivative contained in a liquid non-aqueous electrolyte is 10 parts by volume or less with respect to 100 parts by volume of the non-aqueous solvent.

A gel non-aqueous electrolyte contains a polymer material capable of retaining a liquid non-aqueous electrolyte and a liquid non-aqueous electrolyte. A polymer material capable of gelling a liquid can be used. As such a polymer material, any material that is usually used in this field can be used, and examples include polyvinylidene fluoride, polyacrylonitrile, polyethylene oxide, polyvinyl chloride, polyacrylate, and so on.

A solid electrolyte contains a solute (supporting salt) and a polymer material. As the solute, any of the substances that are listed above can be used. Examples of a polymer material include polyethylene oxide (PEO), polypropylene oxide (PPO), a copolymer of ethylene oxide and propylene oxide, and so on.

The non-aqueous electrolyte secondary battery 1 can be produced by a manufacturing method that includes, for example, an electrode group production step and a battery assembly step.

In the electrode group production step, an electrode group 2 that is a flat wound electrode group is produced. This step includes a winding step and a shaping step. In the winding step, a long positive electrode 5 and a long negative electrode 6 are spirally wound around a prescribed axis line with a separator 7 and a porous insulating layer 8 interposed therebetween so as to produce a wound product whose cross section is circular, elliptic or the like. More specifically, the separator 7 is disposed between the positive electrode 5 and the negative electrode 6 such that they are superimposed. The obtained laminate is spirally wound by using one end of the laminate in the longitudinal direction thereof as the winding axis. The porous insulating layer 8 may be formed on the surface of the positive electrode 5 or the surface of the negative electrode 6, or may be formed on the surface of the positive electrode 5 and the surface of the negative electrode 6.

In the shaping step, a pressure is applied to the wound product obtained in the winding step to shape it into a flat shape so as to produce an electrode group 2. The application of pressure is performed by, for example, pressing or the like.

As a method for forming a crack in the porous insulating layer 8 at a folded portion of the electrode group 2, a method in which the porous insulating layer 8 before winding is pressed can be used. More specifically, the porous insulating layer 8 is formed on the surface of either one or both of the positive electrode 5 and the negative electrode 6 and then a portion of the porous insulating layer 8 where a folded portions 2a is to be located in the produced electrode group 2 is pressed, whereby a crack is formed in that portion. After this, by carrying out a winding step and a shaping step, the electrode group 2 used in the present invention is obtained.

It is preferable that pressing is performed by using, for example, a metal roll such as a stainless steel roll. More specifically, a metal roll is pressed against an appropriate portion of the porous insulating layer 8, and is reciprocated a plurality of times. It is preferable that the roll is reciprocated in the width direction of the porous insulating layer 8. The pressing force is preferably, but not particularly limited to, 0.05 MPa to 2 MPa. When pressing is performed with a pressure within the above range, for example, the occurrence of a fracture that is larger than a crack in portions other than a folded portion 2a is greatly reduced. By doing so, one or more cracks that are sufficient to improve the permeability of non-aqueous electrolyte into the electrode group 2 are formed selectively in primarily the surface of an appropriate portion of the porous insulating layer 8.

Another method for forming a crack in the porous insulating layer 8 at a folded portion 2a of the electrode group 2 is a method in which the composition of the porous insulating layer 8 is limited to a specific range. Specifically, a porous insulating layer 8 that contains 2 to 5 wt %, and more preferably 2 to 4 wt %, of a binder and a remaining amount of inorganic oxide particles is formed. After this, a winding step and a shaping step are performed and, when the porous insulating layer 8 is press-shaped in the shaping step, one or a plurality of cracks are formed in the porous insulating layer 8 wherein a folded portion 2a is to be located.

The amount of binder contained in the porous insulating layer 8 is actually around 10 wt % although a wide range is disclosed in prior art documents. In the present invention, the binder amount is reduced below that of conventional porous insulating layers 8, whereby cracks can be formed selectively in the porous insulating layer 8 at a folded portion 2a. When the binder amount is less than 2 wt % or exceeds 5 wt %, it may become difficult to achieve both sufficient improvement of non-aqueous electrolyte permeability and maintenance of performance of the electrode group 2 to a degree that does not cause any problem in practical use.

Another method for forming a crack in the porous insulating layer 8 at a folded portion 2a of the electrode group 2 is a method in which, in the shaping step, the wound product is press-shaped in a temperature environment of 5° C. or less. By doing so, the binder contained in the porous insulating layer 8 is vitrified. By applying a pressure to the wound product that includes the porous insulating layer 8 containing the vitrified binder so as to shape it into a flat shape, one or a plurality of cracks are formed in the porous insulating layer 8 at a folded portion 2a.

By using these crack forming methods, sufficient cracks for improving non-aqueous electrolyte permeability into the electrode group 2 can be formed selectively in the porous insulating layer 8 at folded portions 2a of the electrode group 2. In addition, the performance of the electrode group 2 can be maintained to a degree that does not cause any problem in practical use. That is, with the above-described crack forming methods, cracks can be formed selectively in the porous insulating layer 8 where folded portions 2a are to be positioned in the electrode group 2 without substantially impairing the performance of the electrode group 2.

In the case of forming cracks by pressing the porous insulating layer 8 before winding, for example, the depth, shape and the like of the cracks can be controlled by adjusting the pressure applied during pressing and the diameter of a roll used for pressing. The roll diameter is preferably 10 to 100 times the thickness of an electrode plate that includes a porous insulating layer.

In the battery assembly step, the electrode group 2 obtained above is housed in a battery case so as to produce a non-aqueous electrolyte secondary battery 1. More specifically, one end of a positive electrode lead is connected to the positive electrode current collector 10 of the electrode group 2, and one end of a negative electrode lead is connected to the negative electrode current collector 12. Insulating plates (not shown) are respectively disposed on both end portions in a direction in which the axis line of the electrode group 2 extends, and the electrode group 2 in that state is housed in a battery case 9. At this time, the other end of the negative electrode lead is connected to the bottom of the battery case 9 that also serves as a negative electrode terminal so as to electrically connect the negative electrode 6 and the battery case 9. Next, a non-aqueous electrolyte is injected into the battery case 9. Furthermore, the other end of the positive electrode lead is connected to a sealing plate that also serves as a positive electrode terminal and, after that, the sealing plate is disposed on the opening of the battery case 9 so as to seal the battery case 9, whereby a non-aqueous electrolyte secondary battery 1 is obtained. The sealing plate may be fitted to the opening of the battery case 9 with a gasket disposed around the perimeter of the sealing plate.

As the positive electrode lead, for example, an aluminum lead can be used. As the negative electrode lead, for example, a nickel lead can be used. As the battery case 9, for example, a bottomed case made of a metal such as iron or aluminum can be used. In the case of using an aluminum battery case, the positive electrode lead is electrically connected to the aluminum battery case. Alternatively, the battery case 9 may be formed of a laminate film made of a material known in the pertinent field.

In the present embodiment, the non-aqueous electrolyte secondary battery 1 of the present invention is produced as a prismatic battery, but the present invention is not limited thereto, and the non-aqueous electrolyte secondary battery 1 of the present invention may have any shape such as a cylindrical shape.

### EXAMPLES

Hereinafter, the present invention will be described in further detail with reference to examples and comparative examples.

### Example 1

### (1) Production of Positive Electrode

A positive electrode material mixture paste was prepared by mixing 100 parts by weight of lithium cobaltate (positive electrode active material), 2 parts by weight of acetylene black (conductive material) and a solution in which 3 parts by weight of polyvinylidene fluoride (PVDF, binder) was dissolved in N-methyl-2-pyrrolidone (NMP). The positive electrode material mixture paste was applied intermittently onto both surfaces of a 15 μm thick strip-shaped aluminum foil (positive electrode current collector, 35 mm×400 mm) and dried and rolled to produce a positive electrode. The total thickness of the positive electrode active material layers formed on both surfaces and the positive electrode current collector was 150 μm. Then, the positive electrode was cut into a prescribed size, and a strip-shaped positive electrode plate was obtained.

### (2) Production of Negative Electrode

Artificial graphite in the form of flakes was pulverized and sized to an average particle size of 20 μm. The obtained material was used as a negative electrode active material. A negative electrode material mixture paste was prepared by mixing 100 parts by weight of the negative electrode active material, 1 part by weight of styrene butadiene rubber (binder) and 100 parts by weight of an aqueous solution of 1 wt % carboxymethyl cellulose. The negative electrode material mixture paste was applied onto both surfaces of a 10 μm thick copper foil (negative electrode current collector), dried and rolled to produce a negative electrode. The total thickness of the negative electrode active material layers formed on both surfaces and the negative electrode current collector was 155 μm. Then, the negative electrode was cut into a prescribed size, and a strip-shaped negative electrode plate was obtained.

### (3) Formation of Porous Insulating Layer

An insulating layer paste was prepared by agitating 950 g of alumina with a median diameter based on volume of 0.3 μm, 625 g of acrylonitrile modified rubber (trade name: BM-720H, solids content: 8 wt %, available from Zeon Corporation, Japan), and an appropriate amount of NMP with the use of a double arm kneader. The insulating layer paste was applied onto the negative electrode active material layer surface of the negative electrode plate with the use of a gravure roll, and dried to form a 4 μm thick porous insulating layer.

Cracks were formed in portions of the porous insulating layer where folded portions were to be located in the wound and press-shaped electrode group by pressing a 3 mm Φ stainless steel roll (pressing force: 0.5 MPa) against thereto, and reciprocating the roll 5 times. This crack formation operation is hereinafter referred to as a “leveling process”. The crack formation portions were observed with an electron microscope, as a result of which, it was found that a plurality of cracks extended in the width direction of the porous insulating layer, the depth of the cracks was 100% of the thickness of the porous insulating layer, and the cross sectional shape of the cracks was V-shaped. No crack was formed in the portions of the porous insulating layer against which the stainless steel roll was not pressed.

### (4) Preparation of Non-Aqueous Electrolyte

A mixed solution was obtained by adding vinylene carbonate in an amount of 1 wt % to a solvent mixture of ethylene carbonate and ethyl methyl carbonate mixed at a weight ratio of 1:3. After that, LiPF₆ was dissolved in the mixed solution such that the LiPF₆ concentration was 1.0 mol/L to prepare a non-aqueous electrolyte.

### (5) Production of Prismatic Lithium Ion Secondary Battery

One end of an aluminum positive electrode lead was attached to the positive electrode current collector. One end of a nickel negative electrode lead was attached to the negative electrode current collector. The positive electrode plate and the negative electrode plate in which a porous insulating layer had been formed were spirally wound with a 16 μm thick porous polyethylene sheet (separator) interposed therebetween. The obtained wound product was pressed in an environment of 25° C. so as to produce a flat wound electrode group. The obtained electrode group was inserted into a prismatic battery case, and then, with the inside of the battery case being in a reduced pressure state, the non-aqueous electrolyte was injected into the battery case. Subsequently, the positive electrode lead and the negative electrode lead were taken out to the outside, and the opening of the prismatic battery case was sealed by disposing a sealing plate thereonto so as to produce a prismatic lithium ion secondary battery of the present invention.

### Example 2

A prismatic lithium ion secondary battery of the present invention was produced in the same manner as in Example 1, except that an insulating layer paste was prepared by agitating 980 g of alumina, 250 g of polyacrylonitrile modified rubber (BM-720H) and an appropriate amount of NMP with the use of a double arm kneader, and that the crack forming operation employing a 3 mm Φ stainless steel roll was not performed.

The crack formation portions were observed with an electron microscope, as a result of which, it was found that a plurality of cracks extended in the width direction of the porous insulating layer, the depth of the cracks was 100% of the thickness of the porous insulating layer, and the cross sectional shape of the cracks was V-shaped.

### Example 3

A prismatic lithium ion secondary battery of the present invention was produced in the same manner as in Example 1, except that the crack forming operation employing a 3 mm 101 stainless steel roll was not performed, and that the wound electrode group was shaped into a flat shape by a press in a temperature environment of 0° C.

The crack formation portions were observed with an electron microscope, as a result of which, it was found that a plurality of cracks extended in the width direction of the porous insulating layer, the depth of the cracks was 100% of the thickness of the porous insulating layer, and the cross sectional shape of the cracks was V-shaped.

### Example 4

A porous insulating layer was formed on the surface of the positive electrode, and cracks were formed in portions of the porous insulating layer where folded portions were to be located in the wound and press-shaped electrode group by pressing a 3 mm Φ stainless steel roll (pressing force: 0.5 MPa) against thereto, and reciprocating the roll 5 times. A prismatic lithium ion secondary battery of the present invention was produced in the same manner as in Example 1, except for this operation.

The crack formation portions were observed with an electron microscope, as a result of which, it was found that a plurality of cracks extended in the width direction of the porous insulating layer, the depth of the cracks was 100% of the thickness of the porous insulating layer, and the cross sectional shape of the cracks was V-shaped.

### Comparative Example 1

A prismatic lithium ion secondary battery was produced in the same manner as in Example 1, except that the crack forming operation employing a 3 mm Φ stainless steel roll was not performed.

### Comparative Example 2

A prismatic lithium ion secondary battery was produced in the same manner as in Example 1, except that an insulating layer paste was prepared by agitating 850 g of alumina, 1875 g of polyacrylonitrile modified rubber (BM-720H) and an appropriate amount of NMP with the use of a double arm kneader, and that the crack forming operation employing a 3 mm Φ stainless steel roll was not performed.

### Test Example 1

Non-aqueous electrolyte impregnation ability was evaluated for the flat wound electrode groups obtained in the same manner as Examples 1 to 4 and Comparative Examples 1 and 2 in the following manner.

### [Evaluation of Non-aqueous Electrolyte Impregnation Ability]

Onto a flat wound electrode group inserted into a battery case, 2 g of non-aqueous electrolyte was dripped using a funnel. Specifically, first, 2 g of non-aqueous electrolyte was divided into six equal parts, each part weighing about 0.33 g. Next, the following operation was performed. The operation comprises: putting about 0.33 g of non-aqueous electrolyte in the funnel to drip it into the battery case; reducing the pressure in the battery case in a time of 40 seconds after the completion of the dripping; maintaining the reduced pressure for 5 seconds; and thereafter opening the battery case to the atmosphere. This operation was repeated 5 times. Subsequently, the remaining part of non-aqueous electrolyte of about 0.33 g was introduced in the funnel, and the entire amount of non-aqueous electrolyte in the funnel was allowed to naturally drip into the battery case and impregnated into the electrode group, to measure the injection time. The injection time refers to the time from the introduction of the remaining part of non-aqueous electrolyte into the funnel until completion of the impregnation. A shorter injection time indicates a more favorable impregnation ability. The results are shown in Table 1.

TABLE 1

| | Electrode Plate | | | | | |
|---|---|---|---|---|---|---|
| | on which Porous | | Amount of Binder | Press | | Injection |
| | Insulating Layer was | Leveling | Contained in Porous | Temperature | Presence/Absence | Time |
| | Formed | Process | Insulating Layer | (° C.) | of Cracks | (sec.) |
| Ex. 1 | Negative Electrode | Yes | 5 wt % | 25 | Present | 5 |
| Ex. 2 | Negative Electrode | No | 3 wt % | 25 | Present | 8 |
| Ex. 3 | Negative Electrode | No | 5 wt % | 0 | Present | 7 |
| Ex. 4 | Positive Electrode | Yes | 5 wt % | 25 | Present | 5 |
| Comp. | Negative Electrode | No | 5 wt % | 25 | Absent | 40 |
| Ex. 1 | | | | | | |
| Comp. | Negative Electrode | No | 15 wt % | 25 | Absent | 35 |
| Ex. 2 | | | | | | |

It can be seen from Table 1 that the electrode groups of Examples 1 and 4 in which cracks were formed in the porous insulating layer at folded portions by a leveling process exhibited a short injection time. It can also be seen from Example 2 that the injection time is shortened by forming cracks in the porous insulating layer at folded portions by reducing the binder amount contained in the insulating layer paste.

Furthermore, it can be seen from Example 3 that when the press temperature was set to a low temperature, the binder contained in the porous insulating layer was brought into a state close to a vitreous state. Accordingly, cracks were easily formed in the porous insulating layer at folded portions and the peripheries thereof. Due to the formation of cracks, the injection time was shortened.

On the other hand, it can be seen that in Comparative Examples 1 and 2 in which no crack was formed, the injection time was long. This is because a non-aqueous electrolyte impregnation path was not secured in the folded portions.

### INDUSTRIAL APPLICABILITY

According to the present invention, it is possible to provide a non-aqueous electrolyte secondary battery that has superior productivity and safety. The non-aqueous electrolyte secondary battery of the present invention is useful as a power source for electronic devices such as notebook personal computers, cell phones and digital still cameras, a power source for storing electrical power, and a power source for electric vehicles that require a high output.

### DESCRIPTION OF REFERENCE NUMERALS

1 Non-Aqueous Electrolyte Secondary Battery
2 Electrode Group
2a Folded Portion
5 Positive Electrode
6 Negative Electrode
7 Separator
8 Porous Insulating Layer
9 Battery Case
10 Positive Electrode Current Collector
11 Positive Electrode Active Material Layer
12 Negative Electrode Current Collector
12a Exposed Portion of Negative Electrode Current Collector
13 Negative Electrode Active Material Layer

1. A non-aqueous electrolyte secondary battery comprising:
(a) a flat wound electrode group that includes a positive electrode, a negative electrode, a porous insulating layer that contains inorganic oxide particles and a binder, and a separator;
(b) a non-aqueous electrolyte; and
(c) a battery case,
wherein said flat wound electrode group has folded portions on both ends in a direction perpendicular to a thickness direction and an axis line, and
at least one crack is formed in said porous insulating layer where one or both of said folded portions is positioned.

2. The non-aqueous electrolyte secondary battery in accordance with claim 1, wherein said porous insulating layer has a thickness of 1 to 10 μm.

3. The non-aqueous electrolyte secondary battery in accordance with claim 1, wherein, in a cross section in a direction perpendicular to the axis line of said flat wound electrode group, said crack has a V shape, W-shape or U-shape.

4. The non-aqueous electrolyte secondary battery in accordance with claim 1, wherein said crack extends in a width direction of said porous insulating layer in a surface of said porous insulating layer.

5. The non-aqueous electrolyte secondary battery in accordance with claim 4, wherein said crack has a depth from the surface of said porous insulating layer of 50 to 100% of the thickness of said porous insulating layer.

6. A method for manufacturing a non-aqueous electrolyte secondary battery comprising an electrode group production step including:
(i) spirally winding a positive electrode and a negative electrode about a prescribed axis line with a separator and a porous insulating layer that contains inorganic oxide particles and a binder interposed therebetween so as to obtain a wound product, and
(ii) applying a pressure to said wound product so as to obtain a flat wound electrode group that has folded portions on both ends in a direction perpendicular to the axis line,
wherein said step (i) comprises forming said porous insulating layer on a surface of either one or both of said positive electrode and said negative electrode and pressing a portion of said porous insulating layer where a folded portion is to be located so as to form a crack in said portion.

7. The method for manufacturing a non-aqueous electrolyte secondary battery in accordance with claim 6, wherein said portion of the porous insulating layer where a folded portion is to be located is pressed with a roll.

8. The method for manufacturing a non-aqueous electrolyte secondary battery in accordance with claim 6, wherein a compressive pressure applied to said portion of the porous insulating layer where a folded portion is to be located is 0.05 MPa to 2 MPa.

9. A method for manufacturing a non-aqueous electrolyte secondary battery comprising an electrode group production step including:
(i) spirally winding a positive electrode and a negative electrode about a prescribed axis line with a separator and a porous insulating layer that contains inorganic oxide particles and a binder interposed therebetween so as to obtain a wound product, and
(ii) applying a pressure to said wound product so as to obtain a flat wound electrode group that has folded portions on both ends in a direction perpendicular to the axis line,
wherein said step (i) comprises forming said porous insulating layer that contains 2 to 5 wt % of said binder and a remaining amount of said inorganic oxide particles on a surface of either one or both of said positive electrode and said negative electrode.

10. A method for manufacturing a non-aqueous electrolyte secondary battery comprising an electrode group production step including:
(i) spirally winding a positive electrode and a negative electrode about a prescribed axis line with a separator and a porous insulating layer that contains inorganic oxide particles and a binder interposed therebetween so as to obtain a wound product, and
(ii) applying a pressure to said wound product so as to obtain a flat wound electrode group that has folded portions on both ends in a direction perpendicular to the axis line,
wherein said step (ii) comprises applying a pressure to said wound product in a temperature environment of 5° C. or less.
